(19) United States
(12) Patent Application Publication
(10) Pub. No.: US 2013/0216967 A1
(43) Pub. Date: Aug. 22, 2013

(54) DEVICE AND METHOD FOR HEAT-TREATING A PLURALITY OF MULTI-LAYER BODIES

(71) Applicants: Martin Fürfanger, Steinhoring (DE); Stefan Jost, Munchen (DE)

(72) Inventors: Martin Fürfanger, Steinhoring (DE); Stefan Jost, Munchen (DE)

(73) Assignee: Saint-Gobain Glass France, Courbevoie (FR)

(21) Appl. No.: 13/813,145

(22) PCT Filed: Aug. 25, 2011
(86) PCT No.: PCT/EP2011/064683

§ 371 Date: May 7, 2013

(30) Foreign Application Priority Data
Aug. 27, 2010 (EP) 10174325.0

(51) Int. Cl. F27D 9/00

(52) U.S. Cl. CPC F27D 9/00
USPC 432/31; 432/77

(57) ABSTRACT

A device for continuous heat-treating of at least two multilayer bodies on at least two process levels disposed one beneath another in at least one heating chamber and at least one cooling chamber, which are arranged one after another is described. The heating chamber of the device has a first process level and a second process level. The cooling chamber of the device has a cooling device, the first process level and the second process level.

The invention relates to a device and a method for heat-treating multilayer bodies, in particular for tempering precursor layers for producing semiconductor layers, which can, for example, be used as absorbers in thin-film solar cells.

Photovoltaic layer systems for the direct conversion of sunlight into electrical energy are sufficiently well known. The materials and the arrangement of the layers are coordinated such that incident radiation is converted directly into electrical current by one or a plurality of semiconducting layers with the highest possible radiation yield. Photovoltaic and extensive-area layer systems are referred to as solar cells.

Solar cells include, in all cases, semiconductor material. Solar cells that require carrier substrates to provide adequate mechanical strength are referred to as thin-film solar cells. Due to the physical properties and the technological handling qualities, thin-film systems with amorphous, micromorphous, or polycrystalline silicon, cadmium telluride (CdTe), gallium arsenide (GaAs), or copper indium (gallium) sulfonide/selenide (Cu(In, Ga)(S, Se)₂) are particularly suited for solar cells. The pentenary semiconductor Cu(In, Ga)(S, Se)₂ belongs to the group of chalkopyrite semiconductors that are frequently referred to as CIS (copper indium diselenide or disulfide) or CIGS (copper indium gallium diselenide, copper indium gallium disulfide, or copper indium gallium disulfoselenide). In the abbreviation CIGS, S represents selenium, sulfur, or a mixture of the two chalcogens.

Known carrier substrates for thin-film solar cells include inorganic glass, polymers, metals, or metal alloys and can, depending on layer thickness and material properties, be designed as rigid plates or flexible films. Due to the widely available carrier substrates and a simple monolithic serial connection, large-area arrangements of thin-film solar cells can be produced cost-effectively.

Thin-film solar cells have, however, compared to solar cells with crystalline or multicrystalline silicon, a lower radiation yield and lower electrical efficiency. Thin-film solar cells based on Cu(In, Ga)(S, Se)₂ have electrical efficiencies that are roughly comparable to multicrystalline silicon solar cells. CI(G)S-thin-film solar cells require a buffer layer between a typically p-conducting CI(G)S-absorber and a typically n-conducting front electrode, which usually contains zinc oxide (ZnO). The buffer layer can effect an electronic adaptation between the absorber material and the front electrode. The buffer layer contains, for example, a cadmium-sulfur compound. A back electrode with, for example, molybdenum, is deposited directly on carrier substrates.

An electrical circuit of a plurality of solar cells is referred to as a photovoltaic module or a solar module. The circuit of solar cells is durably protected from environmental influences in known weather-resistant superstructures. Usually, low-iron soda-lime glasses and adhesion-promoting polymer films are connected to the solar cells to form a weather-resistant photovoltaic module. The photovoltaic modules can be integrated via connection boxes into a circuit of a plurality of photovoltaic modules. The circuit of photovoltaic modules is connected to the public power grid or to an independent energy supply via known power electronics.

A possible method for producing thin-film semiconductors, for example, made of Cu(In, Ga)(S, Se)₂ consists of a two-stage process. Such two-stage methods are known, for example, from J. Palm et al., “CIS module pilot processing applying concurrent rapid selenization and sulfurization of large area thin film precursors”, Thin Solid Films 431-432, pp. 414-522 (2003). There, first, a back electrode made of molybdenum is applied on a substrate, for example, a glass substrate. The molybdenum layer is patterned, for example, with a laser. Then, various precursor layers made of copper, indium, and gallium are deposited on the molybdenum layer, for example, by magnetron cathode sputtering. Also, a selenium layer and/or a sulfur layer are/is deposited on the layer stack by thermal evaporation. The multilayer body thus developed with the precursor layers is heat-treated in a second process. The actual crystal formation and phase conversion of the precursor layers to form the actual semiconductor layer takes place by means of the heat treatment.

The heat treatment occurs, for example, in in-line systems, in which the various process steps occur in different chambers. The different chambers are traversed one after another in a process line. In a simplified structure, an in-line system consists of a loading station, in which the system is loaded with untreated multilayer bodies. Then, the multilayer bodies are transported via an intake air lock chamber into the in-line system. In different heating chambers, the multilayer bodies are heated very rapidly with heating rates up to 50° C./sec and exposed to a specified thermal cycle. The heating is performed, for example, by electrically powered radiant heaters. The method for rapid thermal processing of individual precursor layers into a semiconductor compound is commonly referred to as rapid thermal processing (RTP). Next, the multilayer body is cooled in cooling chambers and/or a cooling line and discharged from the system through an air lock. A method for rapid thermal processing of chalcopyrite semiconductors for use as absorbers in thin-film solar cells is known, for example, from EP 0 662 247 B1.

The heat-treating of the multilayer body is a cost-intensive and demanding process in the production of thin-film solar cells. The process requires high temperatures and precise control of the process atmosphere.

For better control of the heat-treatment process, the process space around the multilayer body can be restricted, for example, by a temporary process box, as is known from DE 10 2008 022 784 A1. By restricting the process space, the partial pressure of the readily volatile chalcogen components such as selenium or sulfur remains largely constant during the heat treatment. In addition, the exposure of the process chamber to corrosive gases is reduced.

Alternatively, the heat-treatment of the multilayer bodies can be carried out in batch operations in stack ovens. Such a stack oven is known from WO 01/29902 A2. The stack oven is used for simultaneous heating and subsequent cooling of a plurality of multilayer bodies in a single chamber. This increases the system cycle time and, thus, reduces system throughput compared to in-line systems, in which heating and cooling are performed in different chambers. The entire stack oven with oven walls and oven fittings is heated parasitically and cooled again during the cooling process. Consequently, compared to in-line systems, in which heating and cooling chambers with walls and fittings are subjected, in continuous operation, to significantly smaller temperature changes, higher energy costs are incurred with stack ovens. The discontinuous batch operation of the stack oven is more difficult to integrate into the overall production process of solar cells or solar modules in large-scale production, which is customarily based on an in-line principle.

The object of the present invention is to improve the devices for heat-treating multilayer bodies known in the prior art in an advantageous manner. In particular, an economical and energy-saving device should be provided, with which system throughput is at least doubled and the investment costs and operating costs are only minimally increased.

This and other objects are accomplished by a device for continuous heat treatment of at least two multilayer bodies according to the independent claims. Preferred embodiments emerge from the subclaims.

As used herein, the term “multilayer body” describes at least one substrate with a plurality of same or different layers applied thereon.

The device according to the invention for continuous heat treatment of at least two multilayer bodies comprises at least one heating chamber and at least one cooling chamber, which are disposed one behind another. The heating chamber and the cooling chamber are preferably separated by an air lock. The device according to the invention has a transport device to transport the multilayer bodies into the heating chamber, from the heating chamber into the cooling chamber, and out of the cooling chamber. The multilayer bodies are situated in the device according to the invention on two process levels, disposed, in particular, above and beneath each other. In the heating chamber, the multilayer bodies are heated by absorption of energy from electromagnetic radiation, preferably by absorption of infrared radiation, particularly preferably by absorption of electromagnetic radiation with a maximum intensity at a wavelength of 1 μm to 2 μm.

The heating chamber comprises at least one first radiator field for heatinga first multilayer body. For example, a first process level to accommodate a first process box for at least one first multilayer body is disposed below the first radiator field. For example, below the first process level, a second radiator field for heating the at least one first multilayer body and at least one second multilayer body is disposed in a second process level. The second process level to accommodate a second process box for at least the second multilayer body is disposed below the second radiator field. A third radiator field for heating the second multilayer body is disposed below the second process level. Thus, the device comprises a first process level with the first process box for at least one first multilayer body, which is situated between the first radiator field and the second radiator field with radiant heaters to heat the first multilayer body, and a second process level with the second process box for at least one second multilayer body, which is situated between the second radiator field and the third radiator field with radiant heaters to heat the second multilayer body.

The terms “first”, “second” and “third” indicate the relative position of the radiator fields to the two process levels, with the first radiator field situated on one side of the process level and the second radiator field situated on the other side of this process level. On the other hand, the second radiator field is situated on one side of the other process level and the third radiator field is situated on the other side of the other process level. Of course, in the case of a device with more than two process levels, a first or third radiator field, respectively, is disposed accordingly adjacent the two outermost process levels, with, in each case, a second radiator field situated between two adjacent process levels.

Advantageously, the two radiator fields of the first process level and the two radiator fields of the second process level are implemented to irradiate the first process level and/or the second process level, in each case, with a different radiation intensity. This means that the first and second radiator field are implemented such that they can emit radiation intensities different from one another to heat the first process level. The first process level can be heated with different radiation intensities on the two sides on which the radiator fields are disposed, for example, on their top and bottom. In this case, the radiation intensity of the first radiator field on one side of the first process level is different from the radiation intensity of the second radiator field on the other side of the first process level. Accordingly, alternatively or additionally, the second radiator field and the third radiator field are implemented such that they can emit radiation intensities different from each other to heat the second process level. The second process level can thus be heated with different radiation intensities on the two sides on which the radiator fields are disposed, for example, on their top and bottom. In this case, the radiation intensity of the second radiator field on the one side of the second process level is different from the radiation intensity of the third radiator field on the other side of the second process level.

As the applicant has noted, the heat input of a multilayer body situated in a process box is usually different on its top and bottom. The reason for this is the different thermal coupling between the multilayer body and the process box, for example, by thermal conduction between the process box and the bottom of the multilayer body due to being supported in the process box or due to different heights of the gas atmosphere on the top and bottom of the multilayer body between the multilayer body and the cover or the floor of the process box. Another reason can be different heating of the cover or floor of the process box by the radiant heaters. Also, the layer structure of the substrate can have a different thermal connection to the process box and/or the radiant heaters.

Generally speaking, the most homogeneous heat distribution possible within the multilayer body is desired, for example, for the controlled conversion of the precursor materials into the absorber in a thin-film semiconductor. The effects mentioned can, however, result in an undesirable inhomogeneity in the heat distribution in the multilayer body. By means of the present invention, it is advantageously possible, through the different radiation intensity of the radiation fields adjacent one and the same process level, to achieve homogenization of the heat distribution in the multilayer body contained in this process level. The present invention thus addresses, for the first time, the problems of inhomogeneous heat distribution in multilayer bodies on multiple process levels, in that the two radiator fields of the first process level and the two radiator fields of the second process level are implemented to irradiate the first process level and/or the second process level, in each case, with a different radiation intensity such that homogeneous heat distribution is achieved in the multilayer bodies to be processed.

The cooling chamber comprises at least the first process level and the second process level, which is, for example, disposed below the first process level. In addition, the cooling chamber comprises a cooling device to cool the first process level and/or the second process level.

In an advantageous embodiment of the device according to the invention, the cooling device comprises at least three cooling plates. The cooling chamber comprises at least one first cooling plate to cool the first multilayer body. For example, the first process level is disposed below the first cooling plate. For example, a second cooling plate to cool the first and second multilayer body is disposed below the first process level. For example, the second process level is disposed below the second cooling plate, and a third cooling plate to cool the second multilayer body is disposed below the second process level. Thus, the first process level is situated between the first cooling plate and the second cooling plate, and the second process level is situated between the second cooling plate and the third cooling plate.

The cooling speed as well as the temperature homogeneity over the multilayer body is affected by the distance between the cooling plate and the multilayer body, by the absorption properties of the cooling plate surface, and by the temperature of the cooling plate. The center cooling plate can consist, for example, of two elements with a different distance to the first and the second multilayer body and cool them with different intensities. The cooling plates customarily have a tube system in their interior and are flowed through by a heat transfer medium such as oil or water. The heat transfer medium is cooled by a cooling unit outside the device. The cooling plates contain, for example, stainless steel or copper.

A device with two process levels disposed one over another is particularly advantageous, since the radiation energy of the second radiator field positioned between them can be used particularly effectively. The electromagnetic radiation that is emitted from the second radiator field directly heats the first and the second multilayer bodies on the first and the second process level.

In a preferred embodiment of the device according to the invention, the radiator fields and the process levels are disposed parallel to each other. In another preferred embodiment of the device according to the invention, the cooling plates and the process levels are disposed parallel to each other.

In advantageous embodiments of the device according to the invention, the radiator fields, process levels, and cooling plates are disposed vertically or horizontally. A vertical arrangement in the context of the invention means that the radiator fields, process levels, and cooling plates are disposed approximately parallel to the base of the system. For the heating chamber, a vertical arrangement means: The first process level is disposed beneath the first radiator field, and the second radiator field is disposed beneath the first process level. Also, at least one second process level is disposed beneath the second radiator field, and at least one third radiator field is disposed beneath the second process level. In the cooling chamber, the cooling plates and process levels are disposed correspondingly beneath each other. By means of the vertical arrangement, the device according to the invention has roughly the same footprint as a device according to the prior art. With the device according to the invention, at least twice as many multilayer bodies can be heat treated simultaneously as with a device according to the prior art. In a horizontal arrangement, radiator fields, process levels, and cooling plates are disposed approximately orthogonal to the base of the system.

In a preferred embodiment of the device according to the invention, in the heating chamber and/or the cooling chamber, at least two multilayer bodies, preferably three multilayer bodies are disposed next to each other in the transport direction on at least one process level. The multilayer bodies disposed next to each other are preferably synchronously transported through the heating and cooling chamber and processed.

In a preferred embodiment of the device according to the invention, at least one multilayer body, preferably two multilayer bodies are disposed in a process box. The process box serves to restrict the process space.

The process box can be designed as a box with a floor, cover, and side walls. Floor, cover, and side walls can contain metal, glass, ceramic, glass ceramic, or graphite. Floor, cover, and side walls can be transparent, partially transparent, or opaque, in particular to the electromagnetic radiation of the radiator fields. Floor, cover, and side walls can absorb the electromagnetic radiation of the radiator fields and be heated themselves. The heated floor, cover, or side walls can then serve as secondary heat sources for heating the multilayer bodies.

The process boxes can be designed quasi gas tight or open. The process boxes can preferably have their own gas connections and be provided with a specific gas atmosphere during specific process steps. The gas atmosphere can, for example, contain reactive gases such as H₂S, H₂Se, S-vapor, Se-vapor, or H₂ as well as inert gases such as N₂, He, or Ar.

Process boxes can be designed with at least a cover and/or a floor made of a material that absorbs the electromagnetic radiation of the radiator field, for example, of graphite.

Heating of the floor and cover creates a secondary heat source which can result in a homogenization of the heat distribution. In the context of the invention, “quasi gas tight” means that the process box is gas tight up to a defined maximum pressure differential between the interior of the process box and the process chamber. When a defined maximum pressure difference is exceeded, a pressure equalization between the interior of the process box and the process chamber occurs. In a suitable design for this, the cover is placed loosely on the frame of the process box. Depending on the tightness of the process box, with quasi gas tight process boxes, a pressure difference between the interior of the process box and the process chamber can be maintained. The free exchange of process gas remains limited and a partial pressure gradient of the process gas develops.

In a preferred embodiment of the device according to the invention, a process box is loaded with, in each case, two multilayer bodies. Multilayer bodies for producing semiconductor layers for thin-film solar cells customarily consist of a glass substrate and a sequence of precursor layers. For the processing of two multilayer bodies in one process box, the two glass substrates can be disposed next to each other such that the two precursor layers face outward. Alternatively, the two precursor layers can face each other. In the “facing each other” case, the two precursor layers are preferably separated from each other by spacing means. A process gas can be supplied to the precursor layers through the space created.

In the device according to the invention, the multilayer bodies or the process boxes loaded with multilayer bodies are moved through the device by a transport mechanism. The transport mechanism can, for example, include a conveyor belt, conveyor chains, or a sled. The transport mechanism can, preferably, include rollers which can, particularly preferably, be driven synchronously by means of V-belts or chain drives, preferably with a drive unit located outside the process chamber. The transport mechanism preferably includes continuous quartz rollers or stub rollers, which are disposed beneath the multilayer bodies or the process boxes. The stub rollers can be disposed inside or outside the radiation field of the radiator fields and are, accordingly, heated more or less. The stub rollers contain, preferably, high-temperature-resistant ceramics, such as Si₃N₄ and BN, or oxide ceramics, such as ZrO₂.

In a preferred embodiment of the device according to the invention, at least two process boxes, preferably three process boxes are disposed next to each other in the transport direction on at least one process level in the heating chamber and/or cooling chamber. The process boxes disposed next to each other are preferably synchronously transported through the heating and cooling chamber and processed.

In a preferred embodiment of the device according to the invention, the cooling chamber has convection cooling or forced cooling. In forced cooling, preferably, a gas stream, particularly preferably a gas stream of an inert gas, circulates through the cooling chamber. The gas stream is cooled on the cooling plates or on suitable cooling bodies. Then, the heated multilayer bodies or the process boxes are cooled by the gas stream. The gas is preferably moved by a fan or a blower. In the case of convection cooling, a circulating gas stream is created by the rising of heated air and the falling of cool air.

In another preferred embodiment of the device according to the invention, the heating chamber has two reflectors. The first reflector is disposed on the side of the first radiator field facing away from the first process level. The second reflector is disposed on the side of the third radiator field facing away from the second process level. The reflectors preferably contain a base body with or without coating, with the reflector having high reflectivity in the wavelength range of the electromagnetic radiation of the radiator fields and/or in the wavelength range of the electromagnetic radiation that emanates from the heated multilayer body or the process box. The base body contains, for example, a ceramic, quartz glass, metal, or similar materials suitable for high process temperatures. The coating of the reflectors preferably contains metals such as gold, silver, molybdenum, aluminum, ceramic compounds such as Al(MgF₂), Al(SiO), MgF₂, SiO₂, Al₂O₃, or quartz nanoparticles.

Without reflectors, the electromagnetic radiation that is emitted by the outer radiator fields in the directions facing away from the process levels is incident on the outer walls of the system. This radiation contributes only to a small extent to the heating of the multilayer bodies. The reflectors reflect a majority of this radiation back into the system and thus onto the multilayer bodies. The efficiency of the radiator fields is increased by the reflectors and energy consumption is reduced.

In an advantageous embodiment of the device according to the invention, the heating chamber and/or the cooling chamber has a device for generating a vacuum and/or a gas atmosphere. The gas atmosphere preferably contains a process gas or an inert gas. Through repeated evacuation and flooding of the process chamber with pure gases, a defined gas atmosphere can be generated. Heating chambers and cooling chambers are preferably sealed against the outside and separated from each other by air locks or slide gates, particularly preferably by vacuum-tight and/or gas-tight airlocks.

A preferred embodiment of the device according to the invention has a plurality of heating chambers and/or a plurality of cooling chambers, which are traversed one after another by the multilayer bodies. A particularly preferred embodiment of the device according to the invention has from two to six heating chambers and from two to six cooling chambers. The various heating chambers and cooling chambers can have different temperatures and different heating or cooling capacities. Multiple individual cooling chambers can also be realized partially or completely in a cooling line, whose length is greater than the length of the individual cooling chambers.

In a preferred embodiment of the device according to the invention, the radiator fields contain linear emitters known per se, in particular electrically operated rod-shaped infrared emitters and/or a matrix of point beam sources known per se. The linear emitters are preferably placed parallel next to each other. Linear emitters and point beam sources are suitable to emit virtually uniform area-wise electromagnetic radiation in the thermal radiation zone.

In one embodiment of the device according to the invention, each radiator field emits electromagnetic radiation of equal intensity toward both sides. In a preferred embodiment of the device according to the invention, the radiator fields have direction-dependent emission characteristics, in particular in the direction of the process levels. For this, linear emitters, for example, are used, which have a reflective coating on one side, made, for example, of ceramic, metal, or nanoporous opaque quartz glass, as is known from DE 10 2005 058819 A1. By means of this measure, the radiation intensity of the radiator fields can be selectively altered for homogenization of the heat distribution in the multilayer bodies in a simple manner. In particular, the radiant heaters of the second radiator field can, in each case, have a one-sided reflector such that they are implemented to irradiate the first process level or the second process level. The radiant heaters to irradiate the first or second process level are, for example, disposed in an alternating sequence.

By means of radiator fields with direction-dependent emission characteristics, in particular, different sides of a multilayer body can be heated with different heat inputs. The same is true for radiator fields with a different radiant power, which can be achieved, for example, by means of a different number of radiant heaters in the radiator fields. It is also conceivable to impinge on the radiant heaters of different radiator fields or one and the same radiator field with a different electrical power in order to obtain a different radiation intensity of the radiant heaters of one and the same radiator field or of the radiation intensity of different radiator fields for homogenization of the heat distribution in the multilayer bodies.

In another preferred embodiment of the device according to the invention, the radiator field that is situated between two process levels comprises two levels of linear emitters or point beam sources, disposed, for example, one beneath another. Another reflector is preferably disposed between the two levels. The two levels can be heated separately from each other. Different process levels can thus be heated to different temperatures.

In another preferred embodiment, the multilayer body to be processed contains a glass substrate with a thickness of 1 mm to 4 mm, preferably of 2 mm to 3 mm. A sequence of layers made of a plurality of thin layers, for example, layers of the sequence silicon nitride/molybdenum/copper-indium-gallium/selenium, is applied on one side of the substrate. The silicon nitride layers have thicknesses of, for example, 50 nm to 300 nm; the molybdenum layers, of, for example, 200 nm to 700 nm; the copper-indium-gallium layers, of, for example, 300 nm to 1000 nm, and the selenium layers, of, for example, 500 nm to 2000 nm.

The object of the invention is further accomplished by a method for continuous heat-treatment of at least two multilayer bodies on at least two process levels, wherein, in a first step, a first multilayer body on a first process level and a second multilayer body on a second process level are transported into at least one heating chamber and heated at heating rates of 0° C. to 50° C./s to a temperature level of 350° C. to 800° C., preferably of 450° C. to 550° C., by means of radiator fields, which are, for example, disposed above and/or below the process levels. Thus, the first process level is situated between the first radiator field and the second radiator field, and the second process level is situated between the second radiator field and a third radiator field. Advantageously, the first and/or second process level are/is, in each case, irradiated with a different radiation intensity such that a homogeneous heat distribution is obtained in the multilayer bodies. Accordingly, the first process level is irradiated by the first radiator field with a different radiation intensity than by the second radiator field, and/or the second process level is irradiated by the second radiator field with a different radiation intensity than by the third radiator field.

In a second step, the first multilayer body and the second multilayer body are transported into a cooling chamber and cooled, at cooling rates of 0° C. to 50° C./s to a temperature of 10° C. to 350° C., preferably to a temperature of 10° C. to 250° C. and particularly preferably to a temperature of 15° C. to 50° C., by means of cooling plates that are disposed above and/or below the process levels. Alternatively, the cooling can occur by means of convection cooling and/or forced cooling. Then, the multilayer bodies are transported out of the cooling chamber.

The method according to the invention can be executed, for example, in the above-mentioned device for heat treatment of at least two multilayer bodies.

In a preferred embodiment of the method according to the invention, the two process levels have the same temperature. In an alternative embodiment of the method according to the invention, the two process levels have different temperatures, for example, through the use of radiator fields with a direction-dependent emission characteristic.

In an advantageous embodiment of the method according to the invention, the heat treatment of multilayer bodies takes place in at least one more heating chamber and/or at least one more cooling chamber, particularly preferably in one to five more heating chambers and/or one to five more cooling chambers. This enables precise control of the processes in the multilayer bodies. In particular, partial processing of the multilayer body up to a specific process phase occurs in each heating or cooling chamber. The multilayer body is then not yet fully processed at the time of transfer from one chamber to the next.

The invention further includes the use of the device for continuous heat treatment of at least two multilayer bodies on at least two process levels disposed one beneath the other.

A preferred use of the device according to the invention is the conversion of precursor layers into a semiconductor layer. The semiconductor layer is preferably used as an absorber in a thin-film solar cell.

The precursor layers are preferably made of copper, indium, gallium, and selenium and are converted in a sulfur-containing atmosphere by rapid thermal processing (RTP) into a Cu(In, Ga)(S, Se)₂-semiconductor layer.

In the following, the invention is explained in detail with reference to figures and a flow diagram. The figures depict purely schematic representations and are not true to scale. The figures in no way restrict the invention.

They depict:

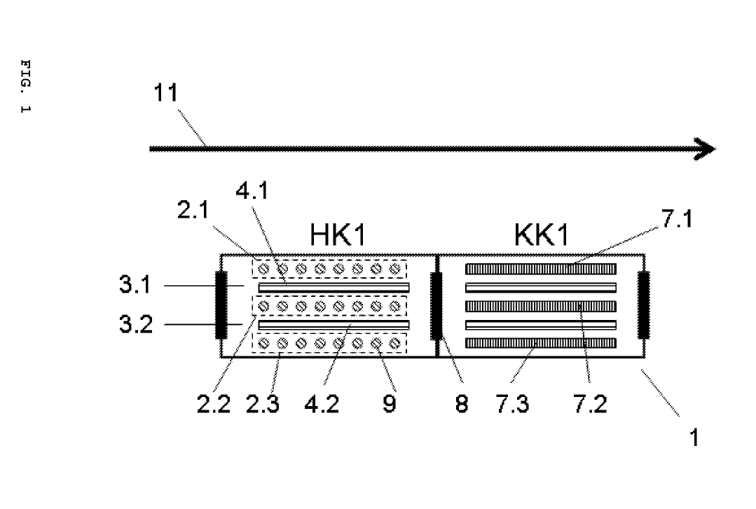

FIG. 1 a cross-section through the device according to the invention for heat-treating two multilayer bodies on two process levels disposed one beneath the other,

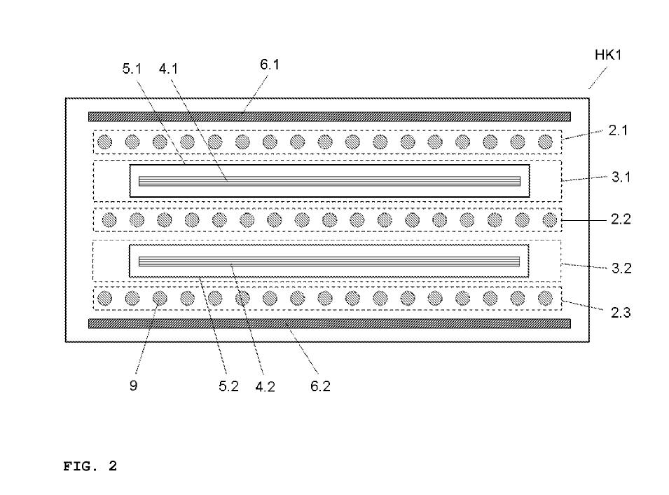

FIG. 2 a cross-section through the heating chamber of the device according to the invention,

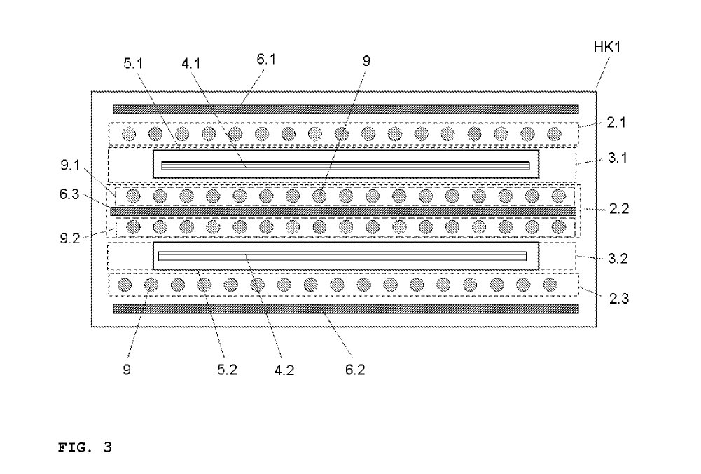

FIG. 3 a cross-section through another embodiment of the heating chamber according to the invention,

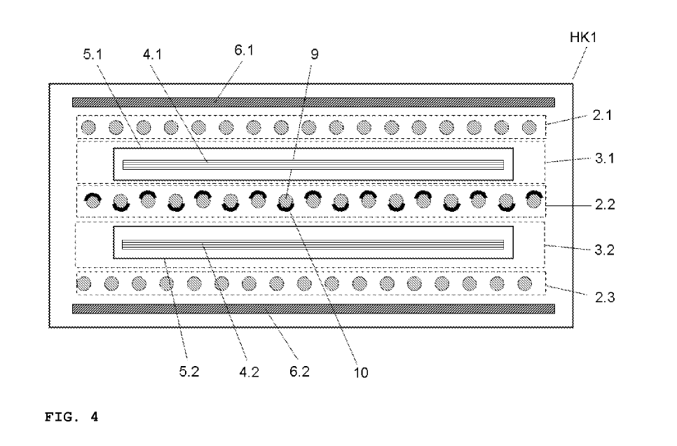

FIG. 4 a cross-section through another embodiment of the heating chamber according to the invention,

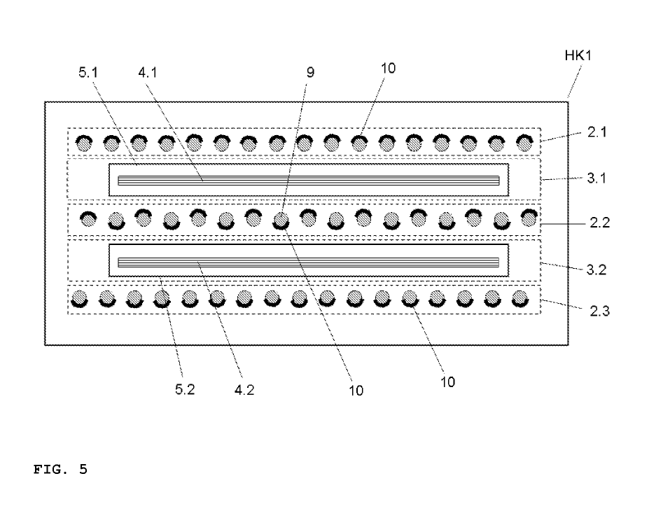

FIG. 5 a cross-section through another embodiment of the heating chamber according to the invention,

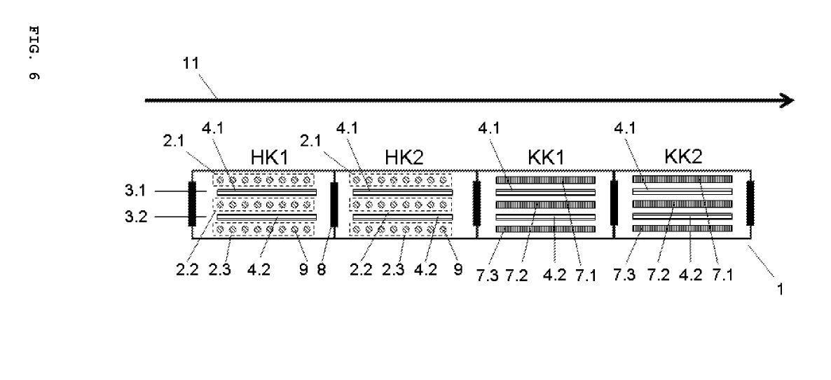

FIG. 6 a cross-section through another device according to the invention with two heating chambers and two cooling chambers,

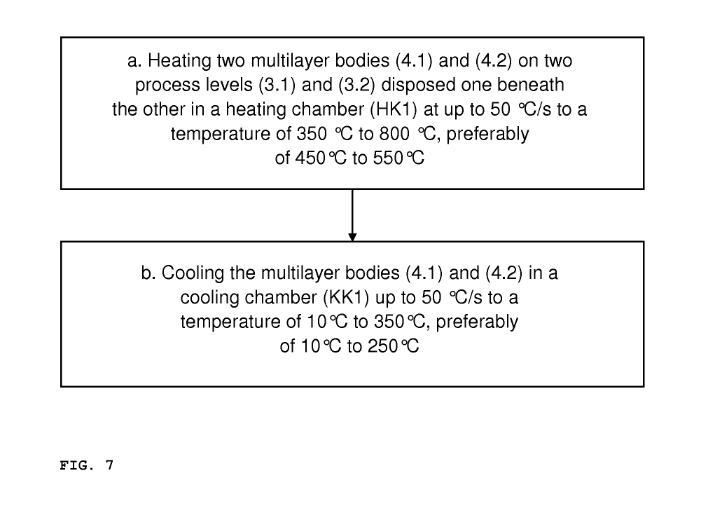

FIG. 7 an exemplary embodiment of the steps of the method according to the invention using a flow diagram.

FIG. 1 depicts the device according to the invention for heat-treating multilayer bodies using the example of an in-line system (1) for selenization of precursor layers by rapid thermal processing (RTP). The in-line system (1) has one heating chamber (HK1) and one cooling chamber (KK1), which are disposed one following the other in the transport direction (11). The in-line system (1) has two process levels (3.1) and (3.2), which are disposed vertically one above the other. A horizontal structure is also provided for according to the invention. In the heating chamber (HK1), a radiator field (2.1) is disposed above the upper process level (3.1), and a radiator field (2.3) is disposed beneath the lower process level (3.2). In addition, a radiator field (2.2) is disposed between the process levels (3.1) and (3.2).

In the cooling chamber (KK1), a cooling plate (7.1) is disposed above the upper process level (3.1), and a cooling plate (7.3) is disposed beneath the lower process level (3.2). In addition, a cooling plate (7.2) is disposed between the process levels (3.1) and (3.2). The cooling plates (7.1, 7.2, 7.3) contain, for example, stainless steel and have in their interior a distribution system for the heat transfer medium. The distribution system is, for example, flowed through by oil or water as a heat transfer medium. The heat transfer medium is cooled in a cooling unit outside the in-line system (1).

The heating chamber (HK1) and the cooling chamber (KK1) are designed vacuum tight and gas tight and connected to vacuum pumps and a device to supply gas. The heating chamber (HK1) and the cooling chamber (KK1) are separated from each other by an air lock (8).

The multilayer bodies (4.1) and (4.2) are situated on the process levels (3.1) and (3.2). The multilayer bodies (4.1) and (4.2) contain, for example, a glass substrate with a molybdenum electrode and a stack sequence of precursor layers that contain copper, indium, gallium, sulfur, and selenium.

FIG. 2 is a schematic representation of an exemplary embodiment of the heating chamber (HK1) of a device according to the invention. The multilayer bodies (4.1) and (4.2) are disposed, in each case, in process boxes (5.1) and (5.2). The process boxes (5.1, 5.2) include a floor and a cover made of glass ceramic and side walls made of graphite. The glass ceramic is transparent to the electromagnetic radiation of the radiator fields (2.1, 2.2, 2.3). The process boxes (5.1, 5.2) are implemented partially gas-tight such that pressure equalization between the interior of the process boxes (5.1, 5.2) and the atmosphere of the heating chamber (HK1) can occur. “Partially gas-tight” means that the cover is placed loosely on the side walls and no further measures for sealing were taken. The process boxes (5.1, 5.2) can also have connectors. A process gas or inert gas, selectively, can be supplied to the process boxes (5.1, 5.2) via the connectors.

The transport of the process boxes (5.1, 5.2) occurs by means of a system of stub rollers. The stub rollers support the process boxes (5.1, 5.2) under their outer edge on the long side. The stub rollers contain, for example, a high-temperature-resistant ceramic. The transport speed between two adjacent chambers typically is typically up to 1 m/s.

A first reflector (6.1) and a second reflector (6.2) are disposed above the first radiator field (2.1) and beneath the third radiator field (2.3). The first reflector (6.1) reflects the upward directed electromagnetic radiation of the first radiator field (2.1) in the direction of the first process level (3.1). The second reflector (6.2) reflects the downward directed electromagnetic radiation of the third radiator field (2.3) in the direction of the second process level (3.2).

FIG. 3 depicts another embodiment of a heating chamber (HK1) according to the invention. The second radiator field (2.2) consists of two levels (9.1) and (9.2) of linear emitters (9) that are separated from each other by a reflector (6.3). By means of a different number of linear emitters (9) in level (9.1) compared to level (9.2), by means of different wiring of the linear emitters (9) in the levels (9.1) and (9.2) and/or by means of a different time-dependent power control in the levels (9.1) and (9.2), a direction-dependent emission characteristic of the second radiator field (2.2) is obtained.

FIG. 4 depicts another preferred embodiment of a heating chamber (HK1) according to the invention. The linear emitters (9) of the second radiator field (2.2) are alternatingly coated on their top side and their bottom side with a reflector layer (10). The reflector layer (10) can contain an opaque nanoporous quartz layer that is applied directly on the linear emitters (9). Alternatively, the reflector layer (10) can include a half-shell made of ceramic. The linear emitters (9) with a reflector layer (10) on the top side and the linear emitters (9) with a reflector layer (10) on the bottom side can be heated to different temperatures.

By means of different radiation outputs and direction-dependent emission characteristics of the radiator fields (2.1, 2.2, 2.3), different sides of a multilayer body (4.1, 4.2) can be heated to different temperatures. Thus, for example, a substrate side of a multilayer body (4.1, 4.2) can be heated to a lower temperature than a side with precursor layers that are to be converted into a semiconductor layer.

FIG. 5 depicts another preferred embodiment of a heating chamber (HK1) according to the invention. The linear emitters (9) of the first radiator field (2.1) are coated on the top side with a reflector layer (10), and the linear emitters (9) of the third radiator field (2.3) are coated on the bottom side with a reflector layer (10). Due to the direction-dependent emission characteristic of the first radiator field (2.1) and of the third radiator field (2.3), it is possible to do without additional reflectors. The use of additional reflectors above the first radiator field (2.1) and beneath the third radiator field (2.3) can increase the efficiency of the direction-dependent emission characteristic.

FIG. 6 depicts another advantageous embodiment of a device according to the invention with two heating chambers (HK1) and (HK2) and two cooling chambers (KK1) and (KK2). The multilayer bodies (4.1) and (4.2) traverse the heating chambers (HK1) and (HK2) and the cooling chambers (KK1) and (KK2) in the transport direction (11). The heating chambers (HK1) and (HK2) and the cooling chambers (KK1) and (KK2) can have different heating and cooling capacities as well as different temperature profiles. This enables particularly precise process control. Thus, for example, the first heating chamber (HK1) can have a higher heating capacity than the second heating chamber (HK2). In the heating chambers (HK1) and (HK2) as well as the cooling chambers (KK1) and (KK2), the multilayer bodies (4.1) and (4.2) are exposed to a desired temperature cycle and a desired process gas atmosphere. Different heating and cooling chambers can have different process atmospheres. In another embodiment of the device according to the invention, further heating and cooling chambers can be disposed one after another. When process control so requires, the heating and cooling chambers can be disposed alternatingly, in other words, a heating chamber can again follow a cooling chamber.

In the exemplary embodiments, the first radiator field (2.1) and the second radiator field (2.2) are implemented such that the top side of the upper multilayer body (4.1) can be heated by the first radiator field (2.1) with a radiation intensity that is different from a radiation intensity with which the bottom side of the upper multilayer body (4.1) can be heated by the second radiator field (2.2). Similarly, the second radiator field (2.2) and the third radiator field (2.3) are implemented such that the top side of the lower multilayer body (4.2) can be heated by the second radiator field (2.2) with a radiation intensity that is different from a radiation intensity, with which the bottom side of the lower multilayer body (4.2) can be heated by the third radiator field (2.3). In this manner, homogeneous heat distribution can be achieved in each of the two multilayer bodies (4.1) and (4.2).

FIG. 7 depicts an exemplary embodiment of the steps of the method according to the invention using a flow diagram. First, in a loading station, the multilayer body (4.1) is placed in a process box (5.1), and the multilayer body (4.2) is placed in a process box (5.2). Then, the process boxes (5.1) and (5.2) are loaded into an intake air lock chamber and the intake air lock chamber is closed. In the intake air lock chamber, through repeated evacuating and flooding with inert gas, a defined and desired process gas atmosphere is established. Then, in process step (a) the process box (5.1) with the multilayer body (4.1) is transported into the process level (3.1), and the process box (5.2) with the multilayer body (4.2) is transported into the process level (3.2).

In the heating chambers (HK1) and (HK2), the desired heating profile (temperature and process gas atmosphere as a function of the process time) is executed: In the heating chamber (HK1), the first multilayer body (4.1) is heated on a first process level (3.1), and the second multilayer body (4.2) is heated on a second process level (3.2) with the radiator fields (2.1, 2.2, 2.3) that are disposed above and/or beneath the process levels (3.1, 3.2). Preferably, the two multilayer bodies (4.1) and (4.2) are heated with a heating rate of 1° C./s to 50° C./s to a temperature of 350° C. to 800° C. using the the radiator fields (2.1, 2.2, 2.3). The multilayer bodies (4.1) and (4.2) are, in each case, heated on their top side and bottom side with a different radiation intensity, in order to obtain homogeneous heat distribution in each multilayer body. Then, in process step (b) multilayer bodies (4.1) and (4.2) are transported into a cooling chamber (KK1). Simultaneously, new multilayer bodies can be introduced into the heating chamber (HK1). In the cooling chambers (KK1) and (KK2), the hot multilayer bodies (4.1) and (4.2) are cooled at a rate of up to 50° C./s to a temperature necessary from a process engineering standpoint. Preferably, the two multilayer bodies (4.1) and (4.2) are cooled at a cooling rate of 0° C./s to 50° C./s to a temperature of 10° C. to 350° C. Due to the decreasing temperature difference between the temperature of the multilayer bodies (4.1) and (4.2) and the temperature of the cooling plates (7.1, 7.2, 7.3), the rate of cooling of the multilayer bodies (4.1) and (4.2) slows. This can be counteracted by appropriate measures, such as reduction of the distance between the cooling plates and the multilayer bodies, for example, by changing the distance as a function of time, or adjusting the temperature of the cooling plates. The cooling process can also be accelerated by a circulating cooled gas stream, for example, a stream of air, argon, or nitrogen. Alternatively, cooling by convection cooling or forced cooling can be realized without cooling plates.

Then, the multilayer bodies (4.1) and (4.2) are transported out of the cooling chamber (KK1) into a discharge air lock chamber and fed to further processing. In the discharge air lock chamber, toxic gases which are present can, for example, be removed. It is also possible for another cooling line or additional cooling chambers to be disposed downstream from the discharge air lock chamber. In certain embodiments, the discharge air lock chamber can be omitted.

As emerges from Table 1 through the example of an in-line selenization system for producing chalcopyrite semiconductors, the device according to the invention offers advantages compared to the prior art.

TABLE 1
Assessment of the potential of the invention

| | In-line selenization | In-line selenization |
|---|---|---|
| | system with one | system according to |
| | process level according | the invention with |
| | to prior art | two process levels |
| Size of footprint | 100% | 100% |
| Investment costs | 100% | 130% |
| System throughput | 100% | 200% |
| Energy costs per | 100% | 70% |
| multilayer body | | |

A device according to the invention with two vertically disposed process levels offers, with a virtually identical system footprint and only minimally higher investment costs, doubled system throughput compared to in-line selenization systems according to the prior art with one process level. Despite the doubled throughput, the space requirement necessary for the system is not increased or is only insignificantly increased, a circumstance which has positive effects on the overall investment and operating costs of a solar factory.

The energy costs per multilayer body are reduced as much as roughly 30% with devices according to the invention. This happens in particular through the effective use of the radiated heat energy of the second radiator field.

This result was unexpected and surprising for the person skilled in the art.

### List of Reference Characters

(1) in-line system

(2.1),(2.2),(2.3) radiator field

(3.1),(3.2) process level

(4.1),(4.2) multilayer body

(5.1),(5.2) process box

(6.1),(6.2),(6.3) reflector

(7.1),(7.2),(7.3) cooling plate

(8) air lock

(9) radiant heater, linear emitter

(9.1),(9.2) level of radiant heaters (9)

(10) reflector layer for radiant heater (9)

(11) transport direction

1. A device for heat-treating at least two multilayer bodies on at least two process levels disposed one beneath another in at least one heating chamber and at least one cooling chamber, which are disposed one behind another relative to a transport direction, wherein
the heating chamber comprises:
a first process level with a first process box for at least one first multilayer body, which is situated between a first radiator field and a second radiator field with radiant heaters for heating the at least one first multilayer body,
a second process level with a second process box for at least one second multilayer body, which is situated between the second radiator field and a third radiator field with radiant heaters for heating the at least one second multilayer body, wherein:
i) the first radiator field and the second radiator field are implemented such that the first process level can be irradiated by the first radiator field with a different radiation intensity than by the second radiator field,
ii) the second radiator field and the third radiator field are implemented such that the second process level can be irradiated by the second radiator field with a different radiation intensity than by the third radiator field, or
iii) the first radiator field and the second radiator field are implemented such that the first process level can be irradiated by the first radiator field with a different radiation intensity than by the second radiator field and the second radiator field and the third radiator field are implemented such that the second process level can be irradiated by the second radiator field with a different radiation intensity than by the third radiator field, and wherein
the cooling chamber comprises:
a cooling device
the first process level for cooling the at least one first multilayer body and the second process level for cooling the at least one second multilayer body.

2. The device according to claim 1, wherein the first, second and third radiator fields have a direction-dependent radiation characteristic for electromagnetic radiation and/or a different radiant power.

3. The device according to claim 2, wherein the radiant heaters have a reflector layer.

4. The device according to claim 3, wherein the radiant heaters of the second radiator field disposed between the at least two process levels have a reflector layer and are implemented to irradiate either the first process level or the second process level.

5. The device according to claim 1, wherein the second radiator field disposed between the at least two process levels has two radiant heater levels with radiant heaters, wherein one radiant heater level of the two radiant heater levels is implemented to irradiate the first process level, and the other radiant heater level of the two radiant heater levels is implemented to irradiate the second process level.

6. The device according to claim 5, wherein a reflector is disposed between the two radiant heater levels.

7. The device according to claim 1, wherein the radiant heaters can be selectively controlled to generate a variable radiation intensity.

8. The device according to claim 1, wherein the first, second and third radiator fields and the at least two process levels are disposed parallel to each other.

9. The device according to claim 1, wherein the cooling device comprises a first cooling plate, a second cooling plate, and a third cooling plate for cooling the at least two multilayer bodies, wherein the first process level is situated between the first cooling plate and the second cooling plate, and the second process level is situated between the second cooling plate and the third cooling plate.

10. The device according to claim 1, wherein the cooling device has a guided gas stream.

11. The device according to claim 1, wherein an air lock or a slide gate is disposed between the heating chamber and the cooling chamber.

12. The device according to claim 1, wherein the at least two multilayer bodies are disposed on one process level next to each other in the transport direction in the heating chamber and/or in the cooling chamber.

13. The device according to claim 1, wherein the heating chamber comprises at least one first reflector and at least one second reflector, wherein the first radiator field is disposed between the at least one first reflector and the first process level, and the at least one first reflector is implemented to reflect electromagnetic radiation of the first radiator field, and wherein the third radiator field is disposed between the second reflector and the second process level, and the second reflector is implemented to reflect electromagnetic radiation of the third radiator field.

14. The device according to claim 1, wherein the heating chamber and/or the cooling chamber has a device for generating a vacuum, a gas atmosphere, or both.

15. A method for the continuous heat-treatment of at least two multilayer bodies on at least two process levels, comprising
a. heating the at least two multilayer bodies in at least one heating chamber with a heating rate of 1° C./s to 50° C./s to a temperature of 350° C. to 800° C. using radiator fields,
wherein a first process level is situated between a first radiator field and a second radiator field, and a second process level is situated between the second radiator field and a third radiator field,
wherein:
i) the first process level is irradiated by the first radiator field with a different radiation intensity than by the second radiator field,
ii) the second process level is irradiated by the second radiator field with a different radiation intensity than by the third radiator field, or
iii) the first process level is irradiated by the first radiator field with a different radiation intensity than by the second radiator field and the second process level is irradiated by the second radiator field with a different radiation intensity than by the third radiator field, and
b. cooling the at least two multilayer bodies in at least one cooling chamber with a cooling rate of 0° C./s to 50° C./s to a temperature of 10° C. to 350° C.

16. The device according to claim 14, wherein the heating chamber and/or cooling chamber has a device that contains a process gas or an inert gas.
